(19) United States
(12) Patent Application Publication
(10) Pub. No.: US 2025/0294106 A1
(43) Pub. Date: Sep. 18, 2025

(54) INFORMATION PROCESSING SYSTEM, INFORMATION PROCESSING APPARATUS, NON-TRANSITORY COMPUTER READABLE MEDIUM, AND INFORMATION PROCESSING METHOD

(71) Applicant: FUJIFILM Business Innovation Corp., Tokyo (JP)

(72) Inventors: Sho NAGASE, Kanagawa (JP); Masahiko HARADA, Kanagawa (JP); Atsushi MORI, Kanagawa (JP)

(73) Assignee: FUJIFILM Business Innovation Corp., Tokyo (JP)

(21) Appl. No.: 18/775,208

(22) Filed: Jul. 17, 2024

(30) Foreign Application Priority Data
Mar. 18, 2024 (JP) 2024-041843

(51) Int. Cl. H04N 1/00

(52) U.S. Cl. CPC H04N 1/00925; H04N 1/00896

(57) ABSTRACT

An information processing system includes a processor configured to: periodically return from a stop state and execute processing related to a packet as periodic processing, and return from the stop state in response to an interruption along with reception of a packet and execute processing related to the packet as aperiodic processing; and stop and no longer execute the periodic processing when there is no packet to be processed.

### CROSS-REFERENCE TO RELATED APPLICATIONS

This application is based on and claims priority under 35 USC 119 from Japanese Patent Application No. 2024-041843 filed Mar. 18, 2024.

### BACKGROUND

### (i) Technical Field

The present disclosure relates to an information processing system, an information processing apparatus, a non-transitory computer readable medium, and an information processing method.

### (ii) Related Art

Conventionally, a multifunction machine in many cases has a function of automatically transitioning to a power saving state in order to reduce consumption of electric power when a non-operating state continues for a predetermined period of time while operating normally. That is, the multifunction machine has, as an operation mode, a power saving mode for operating in a power saving state, separately from a normal mode applied during normal operation. Then, when an operation panel is operated by a user during operation under the power saving mode, the multifunction machine automatically returns from the power saving state, and the operation mode is switched from the power saving mode to the normal mode to return to a normal state where the multifunction machine is available.

By the way, a level of power saving is not uniform depending on specifications of a multifunction machine. For example, there are various levels such as a level at which available functions of peripheral devices such as a printing unit and a scanner unit in a multifunction machine are restricted, a level at which supply of electric power to a peripheral device is stopped, and, furthermore, a level at which supply of electric power to a controller mounted with a central processing unit (CPU) and a memory is stopped.

Incidentally, a multifunction machine may be requested, from an information processing apparatus such as a personal computer (hereinafter referred to as the “PC”), to perform processing such as confirmation of a status of the multifunction machine and printing via a network. For this reason, a necessity of responding to a request via the network may arise internally, even in a power saving state where there is no operation on an operation panel for a predetermined period of time or longer.

For this reason, a controller in a conventional multifunction machine executes processing that is possible to be roughly divided into periodic processing and aperiodic processing under control by an operating system (hereinafter referred to as the “OS”), thereby performing power saving control for further reducing consumption of a slight amount of electric power while repeating operation and stop even in a power saving state.

By the way, periodic processing refers to processing of releasing a stop state due to a periodic timer interruption. Aperiodic processing refers to processing of releasing a stop state due to an interruption such as reception of a packet. When a stop state is released, the controller sequentially processes packets that are received and packets that wait for processing. When entering a state where no processing is performed, which is generally called an idle state, even for a short period of time, the controller transitions to a stop state to reduce consumption of electric power.

Examples of the related art are disclosed in Japanese Unexamined Patent Application Publication Nos. 2001-075687 and 2001-282398.

### SUMMARY

As described above, periodic processing that periodically causes a processor to return from a stop state makes it possible to execute processing related to a packet received through aperiodic processing.

However, a processor has conventionally been caused to return from a stop state by executing periodic processing without any conditions, even when there is no packet to be processed because no packet has been newly received.

Aspects of non-limiting embodiments of the present disclosure relate to improvement of a power saving effect of a processor without failure on receiving a packet, compared with a case where a processor is always periodically caused to return from a stop state in order to execute processing related to a packet.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing system including a processor configured to: periodically return from a stop state and execute processing related to a packet as periodic processing, and return from the stop state in response to an interruption along with reception of a packet and execute processing related to the packet as aperiodic processing; and stop and no longer execute the periodic processing when there is no packet to be processed.

### BRIEF DESCRIPTION OF THE DRAWINGS

An exemplary embodiment of the present disclosure will be described in detail based on the following figures, wherein:

FIG. 1 is a schematic block configuration diagram illustrating a hardware configuration of a multifunction machine according to the present exemplary embodiment;

FIG. 2 is a diagram illustrating transition of consumption of electric power, which changes along with transition of an operation mode in the present exemplary embodiment;

FIG. 3A is a diagram illustrating an execution state of conventional periodic processing in a state where only a controller is in an operable state;

FIG. 3B is a diagram illustrating an execution state of periodic processing according to the present exemplary embodiment in a state where only a controller is in an operable state;

FIG. 4 is a conceptual diagram illustrating execution control for periodic processing in an OS in the present exemplary embodiment; and

FIG. 5 is a conceptual diagram illustrating execution control for periodic processing in the OS when data processing in an application is taken into consideration in the present exemplary embodiment.

### DETAILED DESCRIPTION

A preferred exemplary embodiment of the present disclosure will now be described herein with reference to the accompanying drawings.

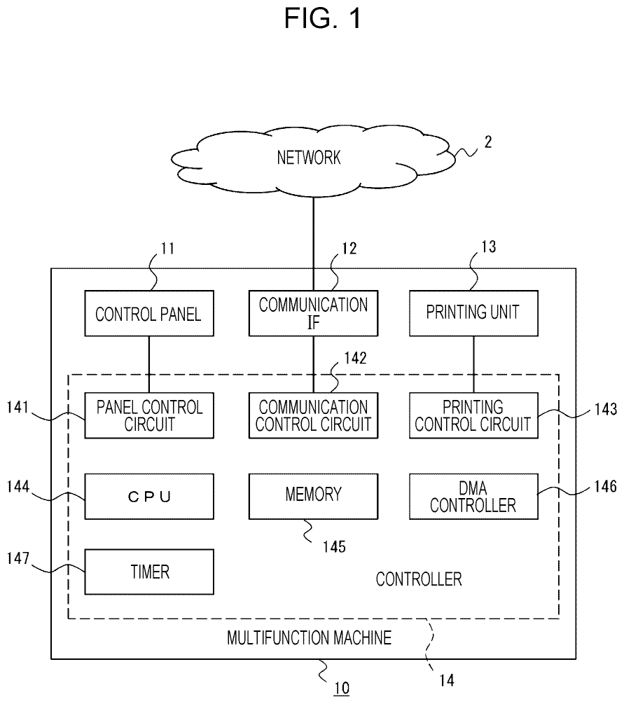

FIG. 1 is a schematic block configuration diagram illustrating a hardware configuration of a multifunction machine 10 according to the present exemplary embodiment. The multifunction machine 10 is one form of an image forming apparatus, and is an apparatus that has various types of functions such as a printing function, a copying function, and a scanner function, and incorporates a computer. The multifunction machine 10 includes a control panel 11, a communication interface (IF) 12, a printing unit 13, and a controller 14. As to hardware, the multifunction machine 10 according to the present exemplary embodiment may be similar or identical to a conventional multifunction machine 10 in configuration. For example, although the multifunction machine 10 includes a non-illustrated scanner for providing a non-illustrated scanner function and a non-illustrated storage unit such as a hard disk drive (HDD), for example, components that are not used to describe the present exemplary embodiment are omitted from FIG. 1.

The control panel 11 serves as a user interface that receives an instruction from a user and displays information. The communication interface 12 is a communication unit that performs data communication with another device via a network 2 such as a local area network (LAN) or the Internet. The printing unit 13 is a printing unit that includes a fixing unit, a heater, a sheet conveyance unit, and the like and performs printing.

The controller 14 is a control board mounted with a panel control circuit 141, a communication control circuit 142, a printing control circuit 143, a CPU 144, a memory 145, a direct memory access (DMA) controller 146, and a timer 147. Note that components in the controller 14, which are not used to describe the present exemplary embodiment, are omitted from FIG. 1.

The panel control circuit 141 controls operation of the control panel 11. The communication control circuit 142 controls operation of the communication interface 12. The printing control circuit 143 controls operation of the printing unit 13. In a case of the present exemplary embodiment, each of the control circuits 141 to 143 performs supply control of electric power to the coupled components 11 to 13.

The CPU 144 is one form of a processor, and performs operation control for various types of mechanisms mounted on the multifunction machine 10, such as the printing unit 13, by providing instructions to the control circuits 141 to 143 in accordance with an operating system (hereinafter referred to as the “OS”) or various types of libraries and an application (hereinafter also simply referred to as an “app”) loaded in the memory 145.

The memory 145 is loaded with pieces of software such as the OS and an application, which are executed by the CPU 144. The memory 145 according to the present exemplary embodiment is formed based on a dynamic random access memory (DRAM). The DRAM is a volatile semiconductor storage device. The DRAM according to the present exemplary embodiment is operable in a self-refresh mode. The term “self-refresh mode” refers to a style for automatically generating a refresh instruction signal inside the DRAM in a state where the DRAM is not operating to execute refresh operation. The term “refresh” refers to operation for periodically supplying electric charge to a memory cell to periodically rewrite a piece of data during operation. By performing refreshing, the piece of data on the DRAM is not erased, but is saved, and, furthermore, it is possible to expect a power saving effect. The DRAM according to the present exemplary embodiment, to which no electric power is supplied when its mode has been transitioned to a power saving mode, is subject to control of refresh under the power saving mode.

The DMA controller 146 is a control board that directly transfers a piece of data between memories or between a memory and an input-and-output (I/O) device without using an accumulator or the like, that is, controls DMA, by executing a programmed instruction group written in a machine language. The timer 147 performs an interruption in the CPU 144. Although the timer 147 is provided in order to perform an interruption in a hardware manner in this exemplary embodiment, an interruption may be performed in a software manner.

Electric power supply control in the multifunction machine 10 described below is achieved mainly by a kernel that is a core of the OS (hereinafter also referred to as an “OS kernel”). The OS used in the exemplary embodiment may be of course pre-installed in the multifunction machine 10, or may be provided via a communication unit, or may be stored in a computer readable recording medium such as a universal serial bus (USB) memory for provision.

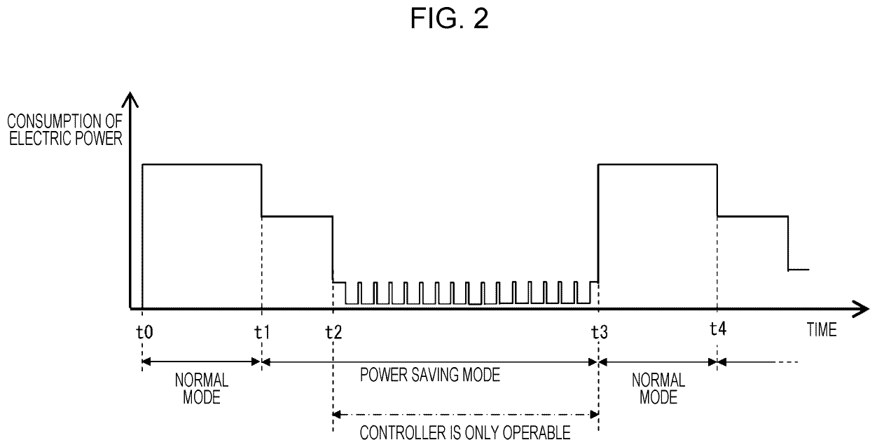

Separately from a normal mode under which it is possible to normally exert a function that a device such as the printing unit 13 has, similar to conventionally existing multifunction machines, the multifunction machine 10 according to the present exemplary embodiment automatically transitions to and operates under a power saving state in order to reduce consumption of electric power when a non-operating state continues for a predetermined period of time while operating under the normal mode, that is, is operable under, as an operation mode, a mode called a power saving mode or a sleep mode (hereinafter referred to as the “power saving mode”). Even under a power saving state, it is possible to take various power saving levels. Note herein that a relationship between the operation modes according to the present exemplary embodiment and consumption of electric power will now be described with reference to FIG. 2.

FIG. 2 is a diagram illustrating transition of consumption of electric power, which changes along with transition of the operation mode in the present exemplary embodiment. In FIG. 2, a horizontal axis represents time, and a vertical axis represents consumption of electric power. Although FIG. 2 illustrates that there is constant consumption of electric power during periods of time between points in time t0 to t1 and t3 to t4 during which the multifunction machine 10 operates under the normal mode, FIG. 2 simply illustrates that electric power to be consumed is relatively greater than that under the power saving mode, and does not illustrate that actual consumption of electric power is constant.

The multifunction machine 10 automatically transitions to the power saving mode at the point in time t1 when a non-operation state continues for a predetermined period of time while operating under the normal mode. In this exemplary embodiment, power saving is performed in a stepwise manner under the power saving mode. That is, at the point in time t1, the panel control circuit 141 and the printing control circuit 143 in the controller 14 stop supply of electric power to the control panel 11 and the printing unit 13 to stop displaying on the control panel 11 and set the printing unit 13 to a state where the unit is not immediately utilized, for example. However, energization to the controller 14 continues.

When this state continues for a predetermined period of time and reaches a point in time t2, energization to the controller 14 is also stopped. Thereby, the memory 145 achieved based on the DRAM starts a self-refresh operation. When energization to the controller 14 is stopped constantly, however, it is not possible to perform processing related to a packet to be transmitted via the network 2, possibly resulting in reception failure.

Therefore, the OS kernel puts the communication control circuit 142 in an energized state to maintain a state where it is possible to receive constantly a packet transmitted via the network 2. Then, the CPU 144 according to the present exemplary embodiment is caused to execute periodic processing and aperiodic processing under control by the OS kernel. In periodic processing, as the timer 147 periodically interrupts, returning from a stop state occurs periodically, and processing related to a packet is executed. In aperiodic processing, returning from a stop state occurs in response to an interruption along with reception of a packet, and processing related to the packet is executed. When the stop state is released, the controller 14 allows electric power to be supplied to the CPU 144 to allow a packet that is received or a packet that waits for processing to be sequentially processed. The illustration in which consumption of electric power increases and decreases during a period of time between the points in time t2 and t3 indicates that, as electric power is supplied to the CPU 144, the CPU 144 is caused to execute processing related to a packet through periodic processing and aperiodic processing. Since it is possible to reduce consumption of electric power during the period of time, in which consumption of electric power is reduced, between the points in time t2 and t3, it is possible to expect a further power saving effect under the power saving mode.

Then, as such an event occurs (at the point in time t3) that is regarded as a condition for releasing the power saving mode, such as the user has operated the control panel 11 while the multifunction machine 10 is operating under the power saving mode, the operation mode in the multifunction machine 10 is switched from the power saving mode to the normal mode.

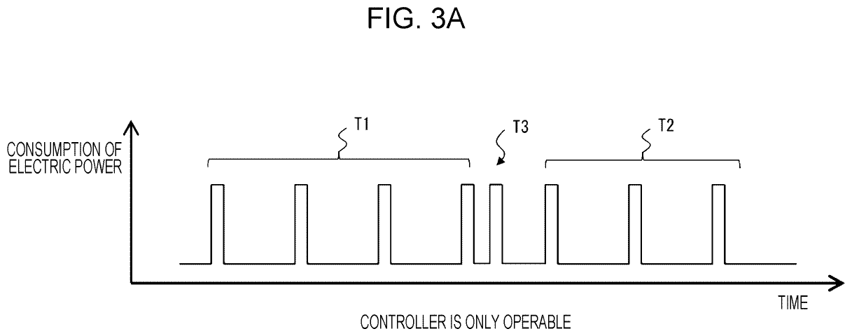

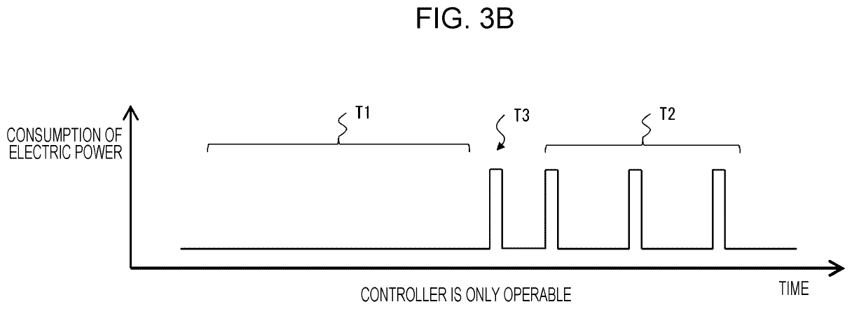

Although the power saving mode is formed as power saving states at two stages, as illustrated in FIG. 2, in the present exemplary embodiment, this is a mere example, and electric power control under the power saving mode may be different from that illustrated in FIG. 2. In the present exemplary embodiment, however, it is assumed that electric power supply control is performed during the period of time between the points in time t2 and t3. Operation of the controller 14 during the period of time between the points in time t2 and t3 will now be further described herein with reference to FIGS. 3A and 3B. Note that, FIGS. 3A and 3B will be described as “FIGS. 3” when the figures are common to each other in the description.

In FIGS. 3, a horizontal axis represents time, and a vertical axis represents consumption of electric power. In FIGS. 3, a part of the period of time between the points in time between t2 and t3 in FIG. 2 is extracted and illustrated. FIG. 3A illustrates that the CPU 144 is executing periodic processing during periods of time T1 and T2. That is, the CPU 144 is supplied with electric power due to timer interruptions, consuming the electric power. FIG. 3B illustrates that the CPU 144 is executing periodic processing only during the period of time T2. Then, it is indicated that the CPU 144 is supplied with electric power and consumes the electric power in aperiodic processing, that is, in response to an interruption due to reception of a packet, during a period of time T3 between the period of time T1 and the period of time T2.

Incidentally, although a packet that waits for processing (hereinafter referred to as an “unprocessed packet”) is processed in periodic processing, the CPU 144 has conventionally been caused to execute periodic processing continuously without stopping, even when there is no unprocessed packet. When there is no unprocessed packet, it is not necessary to cause the CPU 144 to execute periodic processing by supplying electric power. For example, when there is no unprocessed packet during the period of time T1, performing control in such a manner that no electric power is supplied to execute periodic processing as illustrated in FIG. 3A and no electric power is supplied to the CPU 144 as illustrated in FIG. 3B makes it possible to achieve further power saving.

Therefore, in this exemplary embodiment, execution of periodic processing has been controlled in order to achieve a further improved power saving effect.

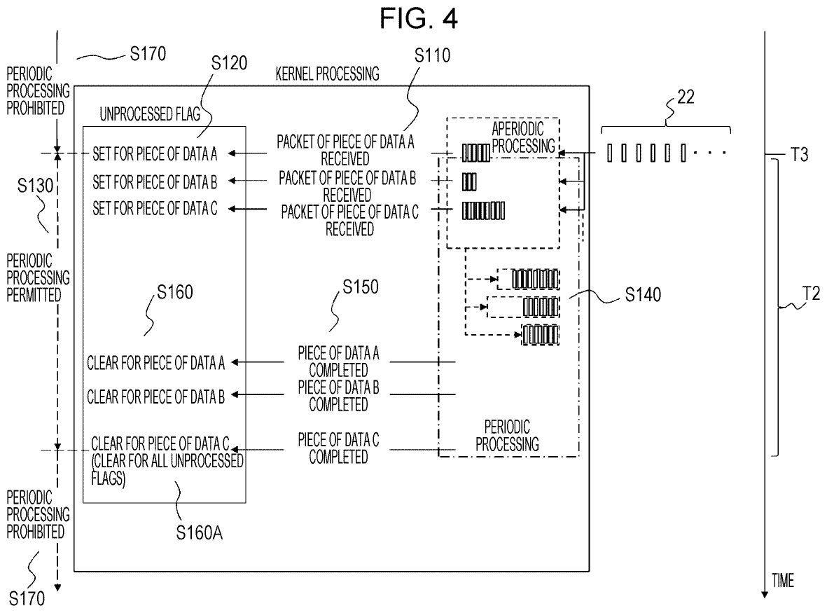

FIG. 4 is a conceptual diagram illustrating execution control for periodic processing in processing performed by the OS kernel (hereinafter also referred to as “kernel processing”) in the present exemplary embodiment. In FIG. 4, a vertical direction in the drawing represents a flow of time, where time flows from top to bottom in the drawing.

The OS kernel is in a standby state until an IO interruption occurs. Furthermore, the DRAM is in a self-refresh state. Then, when an IO interruption occurs due to that the DMA controller 146 has received packets 22, for example, the OS kernel causes the CPU 144 to execute asynchronous processing in response to the IO interruption. Note that, although it is illustrated that the plurality of packets 22 successively transmitted at a certain point in time (T3 in FIG. 3) are collectively received, for purpose of convenience in FIG. 4, this indicates that the packets 22 transmitted via the network 2 are simply received in aperiodic processing, similar to those conventionally performed.

A characteristic feature in the present exemplary embodiment is that, when packets 22 are received, an unprocessed flag is provided for each piece of reception data including the packets 22, and such processing that the unprocessed flag is set is performed. The term “unprocessed flag” refers to a first flag indicating permission or prohibition of execution of periodic processing when returned from a stop state in response to an interruption along with reception of a packet. In the present exemplary embodiment, a state where an unprocessed flag is set means that packets 22 that are not yet processed exist, and, therefore, execution of periodic processing is permitted to process the packets 22. On the other hand, a state where an unprocessed flag is cleared means that packets 22 that are not yet processed do not exist, and, therefore, execution of periodic processing is prohibited because it is not necessary to execute periodic processing to process packets 22. Note that, since periodic processing is executed as the timer 147 has interrupted, prohibition of execution of periodic processing and prohibition of a timer interruption are synonymous with each other.

As the packets 22 are received (step S110), the OS kernel executed in the CPU 144 analyzes the received packets 22 to identify a piece of data that includes the packets 22. At this time, as it is recognized that a packet associated with a new piece of data has been received, the OS kernel creates and sets, to a set state, an unprocessed flag in association with the piece of data (step S120). Then, when there is at least one unprocessed flag being set, the OS kernel permits execution of periodic processing (step S130). In the example illustrated in FIG. 4, as packets 22 for a piece of data A are first received, an unprocessed flag corresponding to the piece of data A is set, thereby permitting execution of periodic processing. Note that, when received packets 22 are not packets 22 for a new piece of data, an unprocessed flag corresponding to the piece of data of the packets 22 has already been created and set, and, therefore, setting processing for an unprocessed flag is unnecessary. Note that a self-refresh operation in the DRAM stops as packets 22 are received.

FIG. 4 illustrates that packets 22 corresponding to three pieces of data A, B, and C are received, and unprocessed flags corresponding to the respective pieces of data are set.

Since there is a state where, when at least one unprocessed flag is set among existing unprocessed flags, execution of periodic processing is permitted, the OS kernel executes packet filtering processing on the received packets 22 in periodic processing (step S140). The term “packet filtering processing” is one of network control functions that a communication apparatus or a computer has, and refers to processing of receiving or discarding a piece of data (that is, a packet) received from outside, in accordance with a certain criterion that is set by an administrator or the like. Therefore, a piece of reception data is generated as packet filtering processing is performed in periodic processing. In the example illustrated in FIG. 4, the pieces of data A, B, and C are generated.

Note herein that, when one piece of data is completed (step S150), the OS kernel clears the unprocessed flag corresponding to the piece of data (step S160). Note that a state where an unprocessed flag is cleared is equivalent to a state where no packet that should be processed exists for the piece of data in periodic processing. Note that the OS kernel may delete the unprocessed flag that has been cleared. When at least one unprocessed flag that has been set exists when an unprocessed flag is cleared, a state where execution of periodic processing is permitted is maintained. Then, although, in FIG. 4, the unprocessed flag corresponding to the piece of data C is cleared upon completion of the piece of data C, the completion of the last piece of data C means that all the unprocessed flags that have been set in association with the respective pieces of data A, B, and C are cleared (step S160A), and, furthermore, no packets 22 that have not yet been processed exist. As described above, the OS kernel that the CPU 144 prohibits execution of periodic processing only after all the unprocessed flags are cleared (step S170).

Since there is no processing that should be executed in periodic processing until an IO interruption along with reception of a packet occurs, the CPU 144 enters a stoppable state. In the present exemplary embodiment, as execution of periodic processing is prohibited, the CPU 144 no longer executes periodic processing. Thereby, since it is possible to stop energization to the CPU 144, it is possible to improve a power saving effect. Furthermore, a self-refresh operation in the DRAM starts.

Although, conventionally, even when there is no packet that should be processed (during the period of time T1 illustrated in FIG. 3), periodic processing is executed as illustrated in FIG. 3A, periodic processing is prohibited and control is performed to no longer execute periodic processing as illustrated in FIG. 3B in the present exemplary embodiment, making it possible to stop the CPU 144 and thus to improve a power saving effect.

Incidentally, to perform processing that is requested from outside on a piece of reception data (the pieces of data A, B, and C described above) generated by performing packet filtering processing, it may be necessary to separately allow a piece of higher-level application software (hereinafter simply referred to as an “application” or “app”) that provides network service processing to run. When execution of periodic processing is prohibited in this case, it is impossible to allow the application to process the piece of reception data. Therefore, in the present exemplary embodiment, execution of periodic processing is allowed to be controlled by taking into consideration data processing in an application. Note that, since a piece of reception data that an application processes is generated from a packet, processing that the application executes corresponds to processing related to the packet.

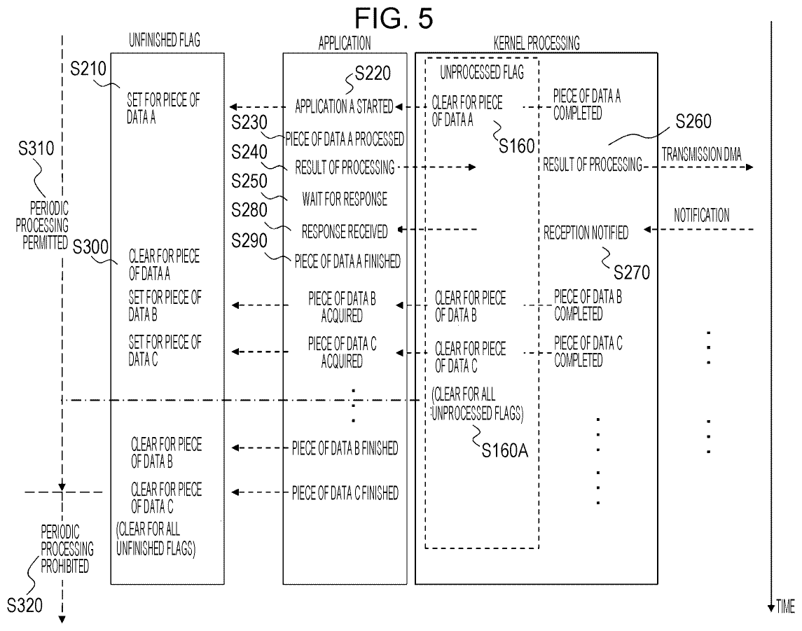

FIG. 5 is a conceptual diagram illustrating execution control for periodic processing in kernel processing when data processing in an application is taken into consideration in the present exemplary embodiment. A vertical direction in the drawing represents a flow of time, where time flows from top to bottom in the drawing. The kernel processing illustrated in FIG. 5, which is identical to the kernel processing described with reference to FIG. 4, is partially omitted for purpose of convenience. Furthermore, in FIG. 5, processing on the piece of data A is focused on, and processing on the pieces of data B and C are appropriately omitted.

When the piece of data A is completed, the unprocessed flag corresponding to the piece of data A is cleared as described above (step S160). Furthermore, when it is determined that it is necessary to execute an application that should process the piece of data A (hereinafter referred to as an “app A”), the OS kernel permits execution of the app A, and also creates and sets, to a set state, an unfinished flag in association with the app A (step S210). The term “unfinished flag” refers to a second flag indicating a state where processing of a piece of data has not yet been finished. A state where an unfinished flag has been set indicates that processing by the application has not yet been finished, that is, data processing by the application has not yet been finished. On the other hand, a state where an unfinished flag is cleared indicates that data processing by the application has been finished. Note that, when no unfinished flag exists, it indicates that processing by the application has been finished or the application has not been started. Furthermore, since an application (e.g., the “app A”) is an application that processes a specific piece of reception data (e.g., the “piece of data A”), it can be said that an unfinished flag is set in association with the application or in association with the piece of data.

As it is started by the OS (step S220), the app A acquires the piece of data A and performs predetermined data processing (step S230). Then, as the processing on the piece of data A ends, the app A transmits a result of the processing to the OS kernel (step S240), and, after that, enters a state of waiting for a response (step S250).

The OS kernel writes the result of the processing, which is received from the app A, in a predetermined storage region on the memory 145 that the DMA controller 146 uses, thereby causing the DMA controller 146 to perform DMA transfer to the source of transmission of the piece of data A (step S260). After that, upon reception of a notification that reception of the result of the processing, which is transmitted from the source of transmission of the piece of data A, is finished (step S270), content being notified is transmitted to the app A.

As the app A that has been waiting for a response receives the notification from the OS kernel (step S280), the data processing is finished (step S290).

At a point in time when the processing on the piece of data A by the app A has been finished, the OS kernel clears the unfinished flag corresponding to the app A (step S300). The OS kernel may delete the unfinished flag that has been cleared.

As described above, an unfinished flag to be provided in association with the piece of data A generated through packet filtering processing is set, and then cleared. Unfinished flags to be set in association with the piece of data B and the piece of data C are also similarly set, and then cleared.

Note herein that a point that should be focused on is that, although, in FIG. 4, execution of periodic processing is prohibited when all unprocessed flags are cleared (step S160A), it is not preferable to prohibit execution of periodic processing at this point in time, when taking into consideration data processing in an application, as described with reference to FIG. 5. That is, it is preferable to allow a piece of application software that processes a piece of data generated from one or more packets to continuously execute processing on the piece of data until it is finished. Then, when a plurality of applications are executing data processing simultaneously and in parallel, it is preferable to allow the CPU 144 to continuously execute periodic processing until execution of all applications is finished. In other words, the OS kernel does not prohibit execution of periodic processing but permits execution while at least one unfinished flag has been set (step S310). Then, the OS kernel prohibits execution of periodic processing only when all the unprocessed flags are cleared, execution of all the applications is finished, and all the unfinished flags are cleared (step S320), and then stops energization to the CPU 144.

Incidentally, execution control for periodic processing by the CPU 144 according to the exemplary embodiment described above becomes possible only when an IO interruption occurs and it is possible to receive a packet through aperiodic processing. However, with a dynamic host configuration protocol (DHCP), it is necessary for a client (in the present exemplary embodiment, the multifunction machine 10) side to actively request allocation of an internet protocol (IP) address, and therefore it is impossible to stop the controller 14 until an IP address is transmitted from the server side and confirmation is made. As described above, since the CPU 144 is stopped in a state where no packet is received from outside and no application is executed, such a case may arise that it is impossible to normally acquire an IP addresses.

Therefore, when a DHCP service is utilized, a condition for prohibiting execution of periodic processing (i.e., a condition for stopping the CPU 144) is added, as a condition, for a coupling state with the network 2, instead of an execution state of an application. For example, such control may be performed that a coupling state of a LAN cable is monitored, and prohibition of execution of periodic processing described above is allowed only when the LAN cable is not coupled to the multifunction machine 10 or only while an IP address is confirmed to allow a packet to be received even when the LAN cable is coupled to the multifunction machine 10.

The “information processing system” according to the present exemplary embodiment, which has been described as being configured by a single multifunction machine 10 as an example as described above, may be configured by one or more information processing apparatuses. Furthermore, the present disclosure may be achieved by an information processing apparatus such as a PC that is able to be coupled to the network 2, instead of the multifunction machine 10 representing one form of the image forming apparatus.

In the exemplary embodiment described above, the processor refers to a processor in a broad sense, and includes general-purpose processors (for example, central processing units (CPUs)) and dedicated processors (for example, graphics processing units (GPUs), application specific integrated circuits (ASICs), field programmable gate arrays (FPGAs), and programmable logic devices).

Furthermore, operations of the processor in the exemplary embodiment described above may be not only operations performed by one processor, but also operations performed, in cooperation with each other, by a plurality of processors that exist at physically distant positions. Furthermore, the order of the operations of the processor is not limited to the order described in the exemplary embodiment described above, and may be appropriately modified.

### Appendix

(((1)))

An information processing system comprising a processor configured to: periodically return from a stop state and execute processing related to a packet as periodic processing, and return from the stop state in response to an interruption along with reception of a packet and execute processing related to the packet as aperiodic processing; and stop and no longer execute the periodic processing when there is no packet to be processed.

(((2)))

The information processing system according to (((1))), wherein the processor is configured to: return from the stop state in response to the interruption, and set a first flag for permitting execution of the periodic processing; and clear the first flag at a point in time when there is no packet to be processed in the periodic processing, and stop.

(((3)))

The information processing system according to (((2))), wherein the processor is configured to stop only when all the first flags that are set in association with respective pieces of data each including one or more packets are cleared.

(((4)))

The information processing system according to any one of (((1))) to (((3))), wherein, even when there is no packet to be processed, the processor is configured not to stop, but to continuously execute the periodic processing, until a piece of software that processes a piece of data generated from one or more packets finishes processing of the piece of data.

(((5)))

The information processing system according to (((4))), wherein the processor is configured to: set a second flag indicating an unfinished state of processing on the piece of data by the piece of software when generation of the data is finished; clear the second flag at a point in time when the processing on the piece of data by the piece of software is finished; and execute the periodic processing without stopping while the second flag is set.

(((6)))

The information processing system according to (((5))), wherein the processor is configured to: return from the stop state in response to the interruption and set the first flag permitting execution of the periodic processing; clear the first flag at a point in time when there is no packet to be processed in the periodic processing; and stop only when all the first flag and the second flag are cleared.

(((7)))

An information processing apparatus comprising the information processing system according to any one of (((1))) to (((6))).

(((8)))

A program causing a computer to execute a process comprising: periodically returning from a stop state and executing processing related to a packet as periodic processing, and returning from the stop state in response to an interruption along with reception of a packet and executing processing related to the packet as aperiodic processing; and stopping and no longer executing the periodic processing when there is no packet to be processed.

(((9)))

An information processing method comprising: periodically returning from a stop state and executing processing related to a packet as periodic processing, and returning from the stop state in response to an interruption along with reception of a packet and executing processing related to the packet as aperiodic processing; and stopping and no longer executing the periodic processing when there is no packet to be processed.

What is claimed is:

1. An information processing system comprising:
a processor configured to:
periodically return from a stop state and execute processing related to a packet as periodic processing, and return from the stop state in response to an interruption along with reception of a packet and execute processing related to the packet as aperiodic processing; and
stop and no longer execute the periodic processing when there is no packet to be processed.

2. The information processing system according to claim 1, wherein the processor is configured to:
return from the stop state in response to the interruption, and set a first flag for permitting execution of the periodic processing; and
clear the first flag at a point in time when there is no packet to be processed in the periodic processing, and stop.

3. The information processing system according to claim 2, wherein the processor is configured to stop only when all the first flags that are set in association with respective pieces of data each including one or more packets are cleared.

4. The information processing system according to claim 1, wherein, even when there is no packet to be processed, the processor is configured not to stop, but to continuously execute the periodic processing, until a piece of software that processes a piece of data generated from one or more packets finishes processing of the piece of data.

5. The information processing system according to claim 4, wherein the processor is configured to:
set a second flag indicating an unfinished state of processing on the piece of data by the piece of software when generation of the data is finished;
clear the second flag at a point in time when the processing on the piece of data by the piece of software is finished; and
execute the periodic processing without stopping while the second flag is set.

6. The information processing system according to claim 5, wherein the processor is configured to:
return from the stop state in response to the interruption and set the first flag permitting execution of the periodic processing;
clear the first flag at a point in time when there is no packet to be processed in the periodic processing, and
stop only when all the first flag and the second flag are cleared.

7. An information processing apparatus comprising the information processing system according to claim 1.

8. An information processing apparatus comprising the information processing system according to claim 2.

9. An information processing apparatus comprising the information processing system according to claim 3.

10. An information processing apparatus comprising the information processing system according to claim 4.

11. An information processing apparatus comprising the information processing system according to claim 5.

12. An information processing apparatus comprising the information processing system according to claim 6.

13. A non-transitory computer readable medium storing a program causing a computer to execute a process comprising:
periodically returning from a stop state and executing processing related to a packet as periodic processing, and
returning from the stop state in response to an interruption along with reception of a packet and executing processing related to the packet as aperiodic processing; and stopping and no longer executing the periodic processing when there is no packet to be processed.

14. An information processing method comprising:
periodically returning from a stop state and executing processing related to a packet as periodic processing, and returning from the stop state in response to an interruption along with reception of a packet and executing processing related to the packet as aperiodic processing; and
stopping and no longer executing the periodic processing when there is no packet to be processed.
